(19) United States
(12) Patent Application Publication
(10) Pub. No.: US 2003/0058497 A1
(43) Pub. Date: Mar. 27, 2003

(54) All-optical switching sites for an agile optical network

(75) Inventors: David W. Park, Kanata (CA); Marc M. Veilleux, Ottawa (CA); Martin Agnew, Stansted Mountfitchet (GB); Nigel Baker, Harlow (GB); Loren S. Berg, Richmond (CA)

Correspondence Address: PEARNE & GORDON LLP, 526 SUPERIOR AVENUE EAST, SUITE 1200, CLEVELAND, OH, 44114-1484, US

(73) Assignee: Nortel Networks Limited, St. Laurent (CA)

(21) Appl. No.: 09/965,269

(22) Filed: Sep. 27, 2001

(51) Int. Cl. H04J 14/02; H04B 10/00

(52) U.S. Cl. 359/127; 359/161

(57) ABSTRACT

An all-optical switching site for extending a range and agility of an all-optical WDM/DWDM network, by controlling signal intensity balance at each link and performing adaptive dispersion compensation for each dropped channel. The all-optical switching site includes a variable optical attenuator (VOA) for each output channel and an adaptive dispersion compensation module (ADCM) in each drop path. The VOAs of output channels transported by an output optical fiber link are controlled with downstream feedback to adjust channel signal intensity balance. The ADCM comprises an adaptive controller and a dispersion compensation element adapted to apply a different amount of dispersion compensation to a channel it receives. The adaptive controller receives feedback from a receiver or a signal analyzer, in order to optimize the dispersion compensation. The all-optical switching site reduces network operational cost, improves network reach and significantly enhances network agility.

### CROSS-REFERENCE TO RELATED APPLICATIONS

This is the first application filed for the present invention.

### MICROFICHE APPENDIX

Not applicable.

### TECHNICAL FIELD

The present invention relates to the field of optical network switching site architectures, and, in particular, to an all-optical add/drop site for use in an agile optical network.

### BACKGROUND OF THE INVENTION

Prior art all-optical networks include optical fiber links between network elements that use wave division multiplexing (WDM) or dense wave division multiplexing (DWDM) to convey data over a plurality of channels. Each optical fiber link may include a plurality of optical devices, including amplifiers (commonly erbium doped fiber amplifiers (EDFAs)) provisioned at fixed intervals between the terminals, used to boost the channel signal intensities of the plurality of channels. Each channel uses a narrow band of wavelengths (that does not overlap the wavelengths used by any other channel) to carry a signal. Channels are routed through the optical fiber links at switching sites, and originate/terminate at add/drop paths of add/drop sites, etc. Each drop path receives a channel, and converts a signal carried on the channel into a digital electrical signal. The electrical signal may then be; re-issued into the optical network on any channel by an add path, issued onto another network (optical or other), or may be fed to a signal processor. As is known in the art, the conversion from optical to digital electrical signals, and then back to optical signals (OEO conversion) is time consuming, power intensive, and limits the efficient use of optical fiber link bandwidth. All-optical switches (switches that do not perform OEO conversion) can receive and transmit many more channels than switches that perform OEO conversion.

OEO conversion is the most reliable way to regenerate a signal that has been degraded during transmission through a channel over one or more optical fiber links. OEO conversion also facilitates cross-connection of signals. Once the signal has been converted into a digital electrical signal, it can just as easily be converted to any outgoing channel and sent on any available output optical fiber link. The outgoing signal will have no dispersion, signal power loss or distortion when it is re-transmitted.

The distance between regeneration points (i.e., the reach of a channel) may be extended using many known techniques such as Raman pumping and forward error correction encoding schemes. These techniques permit channels to carry signals in all-optical networks over distances far in excess of one optical fiber link. It is therefore desirable to use all-optical switching to relay signals over multiple optical fiber links.

Although all-optical networks are known in the prior art, because of certain problems associated with the propagation of optical signals over long distances, those networks have limited reach and agility, and in their bandwidth utilization. The reach of a network governs the size of a geographical area that can be served by the network. The agility of the network determines how readily the network can be reconfigured to adapt to changes in the data traffic within the area served by the network.

All-optical networks that use standard optical fiber may use only a small band in which wavelengths are not subject to substantial chromatic dispersion. Using “C” and “L” bands of wavelengths, on the other hand, significantly many more channels of data can be conveyed concurrently. The C and L bands, however, are subject to chromatic dispersion in standard optical fiber. Chromatic dispersion limits the distance over which a channel can be carried on an optical fiber before regeneration, and hence the distance data can be conveyed in an all-optical network. The distance between regeneration points of prior art all-optical networks that use the C and/or L bands are severely restricted by chromatic dispersion.

In prior art all-optical networks, a bulk dispersion slope compensation module (DSCM) is typically used to compensate for local dispersion (dispersion incurred as a result of transmission over one optical fiber link). DSCMs are adapted to concurrently correct for dispersion in all of the channels carried in an optical fiber link, to within a predefined tolerance. The predefined tolerance allows for some uncorrected dispersion to remain across some of the channels. As the channels traverse a plurality of optical fiber links without regeneration, uncorrected dispersion remaining after each optical fiber link accumulates, causing intra-channel dispersion of the data carried in channels. Intra-channel dispersion causes loss of signal quality (signal Q).

As is known in the art, the peak intensity of the channel is conveyed on the center wavelength of the channel, but some channel intensity is spread across neighboring wavelengths. These neighboring wavelengths are received before or after the center wavelength because of the chromatic dispersion. When the temporal spread of the wavelengths exceeds a fraction of the bit interval (the inverse of the bit rate) of the signal, the bit pulses of data overlap each other, severely distorting the signal. This intra-channel dispersion can exceed the tolerances of receivers, rendering the signal carried on the channel indecipherable. So, as the number of optical fiber links that the channel traverses increases, so does uncorrected dispersion and intra-channel dispersion. To permit the number of optical fiber links traversed by a channel to be extended, a mechanism for compensating for varying amounts of dispersion in an adaptive manner is required.

Agility in an optical network with an all-optical layer is also limited by phenomena called non-linearities (such as Stimulated Raman Scattering, Cross-phase modulation, Self-phase modulation, etc.). These non-linearities result in the exchange of signal power across adjacent channels. In an all-optical network these effects must be controlled for signals that have traversed different paths and may have a large disparity in signal intensities.

In prior art optical networks that do not employ all-optical switching, channels travel over point-to-point optical fiber sections prior to regeneration. Consequently, control feedback systems designed to balance signal intensities on adjacent channels in such optical networks, are used to control non-linearities. The channel transmitters receive the control feedback information and adjust transmitted powers to optimize the signal to noise ratio of the optical signal received at downstream amplifiers, etc. In an all-optical network, channels are dropped and added to optical fiber links in dependence upon traffic patterns. These channels will traverse varying lengths of optical fiber and have varying signal intensity and net dispersion.

There therefore remains a need for an all-optical switching site for use in WDM/DWDM optical networks that performs all-optical switching and enables construction of an agile optical network with improved reach.

### SUMMARY OF THE INVENTION

Accordingly, an object of the present invention is to provide all-optical switching sites for use in wave division multiplexed (WDM) and dense wave division multiplexed (DWDM) optical networks, that enables the construction of an agile optical network.

Another object of the invention is to provide all-optical switching sites that correct for dispersion accumulated over a variable number of optical fiber links, at each drop path.

A further object is to provide an all-optical switching site adapted to provide intra-channel signal intensity balance for channels conveyed through the all-optical switching site. This is used to provide optimum signal powers, signal to noise ratios, signal quality (Q), and to minimize the effect of non-linearities in the output fibers.

Accordingly, the present invention provides an all-optical switching site containing at least one all-optical switch, known in the art as a photonic cross-connect (PXC). A PXC and a set of add and drop paths constitute an optical add/drop multiplexer. The PXC(s) may cross-connect all of the channels of one optical fiber with its add and drop paths, it may cross-connect a sub-set of the channels of one optical fiber with add/drop paths and the rest of the channels to one or more output fibers, or it may cross-connect channels of a plurality of optical fibers with add/drop paths, and/or with each other. The cross-connection of a channel from one input optical fiber link to an output optical fiber link requires channel translation if the wavelength of that channel overlaps with the wavelength of a channel in the output optical fiber link. A preferred all-optical switching site involves a plurality of optical fibers, each with a respective PXC. Each of the PXCs is connected with a plurality of transfer add/drop paths that serve to interconnect the PXCs. Each transfer add/drop path of one PXC is a transfer drop/add path of another PXC. This architecture permits a fraction of the channels to be cross-connected on respective add/drop paths.

In accordance with another aspect of the invention, the all-optical switching site further includes an adaptive dispersion control module (ADCM) in each drop path, the ADCM being adapted to fine tune the dispersion compensation of a signal carried on a received channel. Each ADCM is preferably provisioned to receive a coarse-grain dispersion compensation adjustment setting during the provisioning of the channel switching, so that if the signal received at the ADCM is changed from another signal having been carried on a channel that has traversed a radically different optical path, and consequently incurred a different amount of net dispersion, the ADCM can be set to correct for an approximate intra-channel dispersion of the new signal. The approximate residual dispersion may be calculated based on one or more of the factors that affect dispersion, including: the distance traversed over optical fiber links of respective types, the amount of bulk dispersion slope compensation in respective optical fiber links, and the center wavelength of the channel.

Additionally, the ADCM is adapted to fine tune the dispersion compensation with control feedback. The control feedback will include a value of a parameter that varies with dispersion, which could be a signal-to-noise ratio, signal Q, a bit error rate (BER), a measure of a spectral content, and/or a direct measure of dispersion. Specifically, an “eye-closure” diagram, familiar to those skilled in the art, used to optimize optical to electrical conversion in the receiver, can measure the amount of dispersion, or the signal quality and forward this data to the ADCM. Alternatively, the ADCM can generate its own control feedback, which avoids the re-provisioning of incumbent receivers. In the alternative case, output of a dispersion compensation element is tapped, to produce a low power sample of the signal. The sample then undergoes optical to electrical (OE) conversion in a manner known in the art. The result of the OE conversion is that the intra-channel dispersion of the signal is determined by means such as spectral content. The intra-channel dispersion is forwarded to an adaptive control, which alters the amount of dispersion compensation applied to the signal by the dispersion compensation element. The ADCM would therefore further require a receiver and tap. In a second alternative case, the sample could be directly inspected without conversion to an electrical signal. Instead, an optical signal analyzer may be used to generate the value of a parameter that varies with intra-channel dispersion.

In accordance with a third aspect of the invention, a means for adjusting the intensity of signals carried on individual channels is provided, enabling the modification of channel signal intensities in the bulk optical signal at every all-optical switching site. The intensity of each channel signal is controlled at the all-optical switching site, to optimize the performance of all the wavelengths in the output fiber. The wavelengths may be optimized for a particular profile of power (flat, tilted, or other) optical signal-to-noise ratio, signal Q, non-linearities, etc. The target profile may be set locally, by the optical receiver at the end of the link or by intermediate optical amplifier sites. This control may be exerted by a variable optical attenuator (VOA) for each channel, located between a point at which the channels are de-multiplexed and a point where they are multiplexed in the all-optical switching site. Each VOA attenuates a respective channel, reducing the channel's intensity, to adjust channel intensities on outbound fiber. In order to maximize performance, a control feedback loop connected to downstream amplifiers is used to dynamically alter the settings of each of the VOAs, preferably with an intervening VOA controller adapted to control the amount of attenuation applied to all of the channels that can be multiplexed onto a given output optical fiber link.

### BRIEF DESCRIPTION OF THE DRAWINGS

Further features and advantages of the present invention will become apparent from the following detailed description, taken in combination with the appended drawings, in which:

FIG. 1 is a schematic diagram illustrating principal functional elements used in an all-optical add/drop switch for a WDM optical network, known in the art;

FIG. 2 is a schematic diagram illustrating principal functional elements used in an all-optical switching site in accordance with the invention;

FIG. 3 is a schematic diagram illustrating principal functional elements used in an all-optical switching site in accordance with the invention that permits selected channel signals to bypass the PXC;

FIG. 4 is a schematic diagram illustrating principal functional elements used in an all-optical switching site in accordance with the invention that performs limited cross-connection of channel signals between two optical fibers;

FIG. 5 is a schematic diagram illustrating principal functional elements used in an all-optical switching site in accordance with the invention that cross-connects channel signals between two respective optical fibers; and

FIG. 6 is a schematic diagram illustrating principal functional elements used in an adaptive dispersion compensation module (ADCM) in accordance with the present invention.

It should be noted that, throughout the appended drawings, like features are identified by like reference numerals.

### DETAILED DESCRIPTION OF THE PREFERRED EMBODIMENT

The invention enables all-optical switches to be incorporated into WDM/DWDM optical networks to form agile optical networks with improved reach, agility and channel capacity. An agile optical network is, for the purpose of this invention, a readily re-configured WDM/DWDM all-optical network adapted to perform all-optical switching of channels, the wavelengths of which fall within a dispersive band, and may extend over a plurality of optical fiber links.

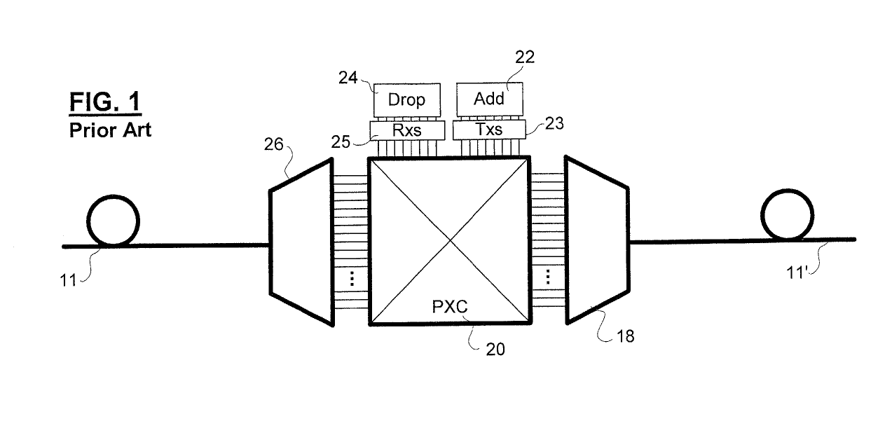

FIG. 1 illustrates an all-optical add/drop switch incorporating an optical add/drop multiplexer, for use in a WDM optical network that is known in the art. The all-optical add/drop switch comprises a demultiplexer 18 adapted to separate a bulk optical signal received on an input optical fiber link 11 into component channels, in a manner known in the art. Each channel is then switched by a photonic cross-connect (PXC) 20 to either a corresponding output channel, or a drop path 24. The PXC 20 also switches added channels from respective add paths 22 to corresponding output channels. The output channels are multiplexed by a multiplexer 26 to form a bulk output optical signal transmitted on the output optical fiber link 11′.

As is known in the art, there may be a plurality of input and/or output optical fiber links terminated at the all-optical switching site, the only limit being that imposed by the switching capacity of the PXC 20. It is also known in the art to amplify the received optical signal before and/or after the PXC, and to perform bulk dispersion compensation of the bulk optical signal prior to demultiplexing, or after multiplexing.

Each of the add paths 22 is equipped with a transmitter 23, which may be a tunable laser, or any other means for emitting modulated optical signals on one channel at one time, and later on another channel. Each of the drop paths are equipped with a respective receiver 25, which includes a photodetector adapted to absorb the incident channel signal's light, and convert the signal into an analog electrical signal, and a circuit for discriminating 1's and 0's. Both the add and drop paths may be connected with an OEO switch that is adapted to regenerate a channel's signal. The dropped signal may be returned to the all-optical layer on the same or any other available channel; it may be switched to another network; or it may be received and processed by the receiver's processor.

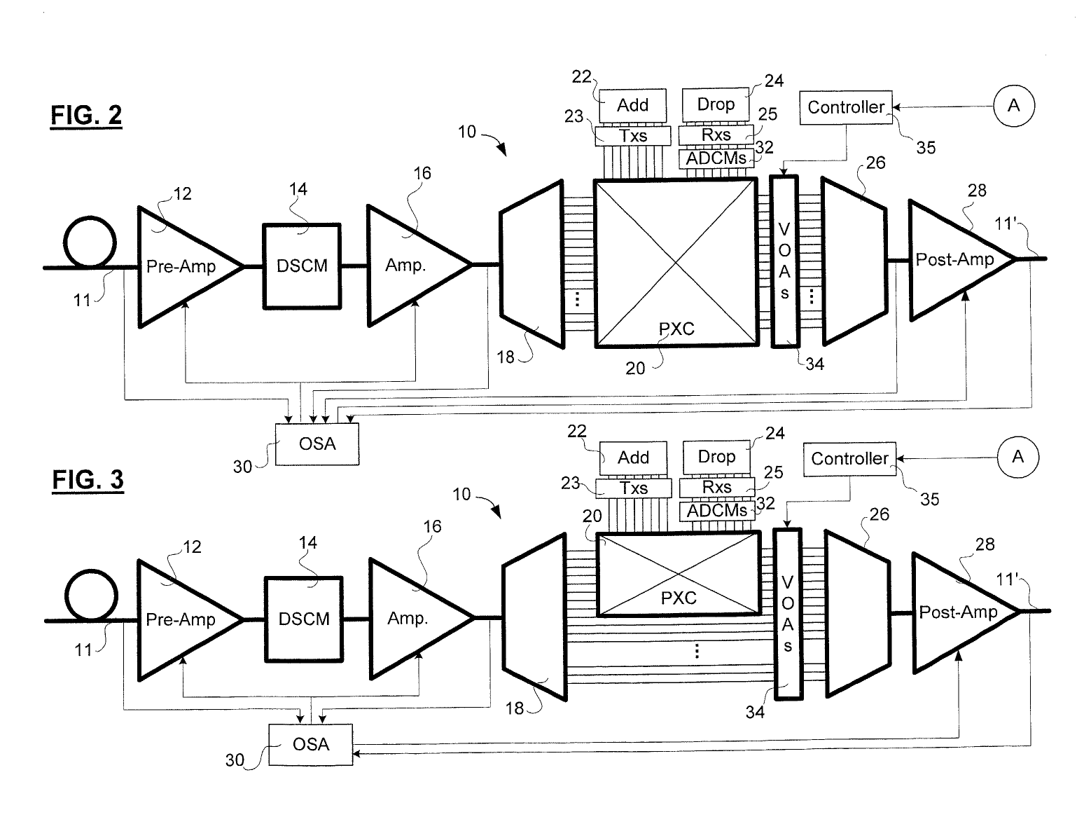

FIG. 2 illustrates an optical switching site 10 in accordance with the present invention. An input optical fiber link 11 carrying wavelength division multiplexed optical signals is first amplified by a pre-amplifier 12. The bulk optical signal (the aggregate of multiplexed channels) is then dispersion corrected, by a dispersion slope compensation module (DSCM) 14. The bulk optical signal is then amplified by a power amplifier 16, and sent to a de-multiplexer 18. The de-multiplexer 18 separates the bulk signal into respective channels, which are sent, in parallel, to the PXC 20. The PXC 20 switches the respective channels and a set of added channels (received from transmitters 23 of respective add paths 22), to output channels and drop paths 24. Prior to transmission over the optical fiber link 11′, the output bulk optical signal is amplified by post-amplifier 28, in order to boost the channel powers of the constituent channel signals.

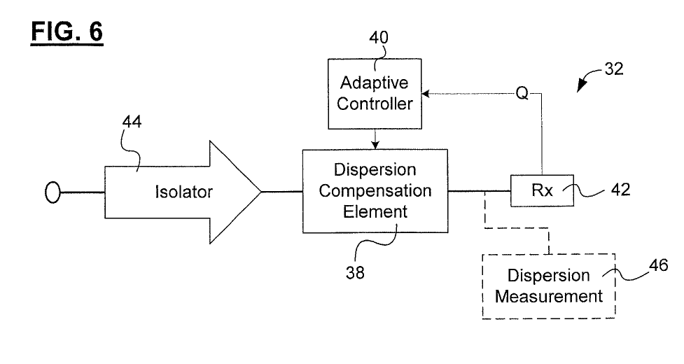

Two devices are further added to provide the all-optical switching site 10 in accordance with the invention. An adaptive dispersion compensation module (ADCM) 32 is added to each drop path 24 connected to the PXC 20, to perform dispersion compensation on an individual channel. This will compensate for dispersion accrued over a variable number of optical fiber links traversed by the channel, prior to optical fiber link 11, for which the DSCM 14 does not compensate. The operation of the ADCM 32 control is further discussed with reference to FIG. 6.

The DSCM 14 corrects for a mean dispersion of all channels carried by the optical fiber link 11. The DSCM 14 therefore cannot compensate for channel dependent dispersion, if different channels have followed different optical paths. Receivers in the cross-connect 20 are usually adapted to tolerate a limited amount of intra-channel dispersion.

The pre-amplifier 12 and power amplifier 16 are used to boost the bulk optical signal, prior to de-multiplexing, as they are presumed to be required for the present embodiment. An optical spectrum analyzer (OSA) 30 is used to dynamically adjust the gain settings of the pre-amplifier 12, the power amplifier 16, and the post-amplifier 28 using per wavelength measurement of power and/or a signal to noise ratio. There may be any number of amplifiers and amplifier control systems (such as the OSA) in different embodiments depending on; the strength of the signals entering the all-optical switching site 10 in respective channels, a loss of signal strength incurred during transit through the all-optical switching site 10, and the signaling requirements for transmission on optical fiber link 11′. The bulk optical signal is tapped before, after, or before and after each amplifier (in this case the pre-amplifier 12 the power amplifier 16, and the post-amplifier 28) that the OSA controls. As is known in the art, tapping involves removing a portion of the bulk optical signal, and sending the low intensity sample of the bulk signal along a separate optical path, in this case, to the OSA 30. These bulk signals are compared to determine the differences in spectral qualities of the bulk optical signal before and after amplification. The comparison is used to adjust the gain settings of the pre-amplifier 12, the power amplifier 16, and the post-amplifier 28.

The second new device included in the all-optical switching site 10 shown in FIG. 2, is a variable optical attenuator (VOA), controlled by a controller 35. Each of the VOAs 34 interfaces a respective one of the de-multiplexed channels. The VOAs 34 in FIG. 2 are located immediately prior to multiplexing, enabling control of intra-channel signal intensity balance in order to optimize performance on outbound optical fiber link 11′ upon which the channels are conveyed. The control of the VOAs 34 involves receiving feedback from a downstream signal analyzer that calculates channel signal intensity balance, and issues a message to the controller 35. The controller 35 uses the feedback to determine changes to the attenuation of individual channels, and uses control signaling to effect the changes.

A second embodiment incorporating a PXC 20 into an all-optical switching site 10 is illustrated in FIG. 3. In accordance with the second embodiment, a predefined set of channels are provisioned as by-pass channels, while the remainder are provisioned as add/drop channels. The add/drop channels are terminated at the PXC 20 and are switched to either a respective drop path, or a corresponding output channel. Added channels are switched to corresponding output channels. Signals carried on the by-pass channels do not incur the insertion loss caused by transport across the PXC 20, as they are not switched. As is known in the art, the size and configuration of optical switches determines the signal intensity loss incurred as a signal is conveyed through the switch (generally referred to as insertion loss).

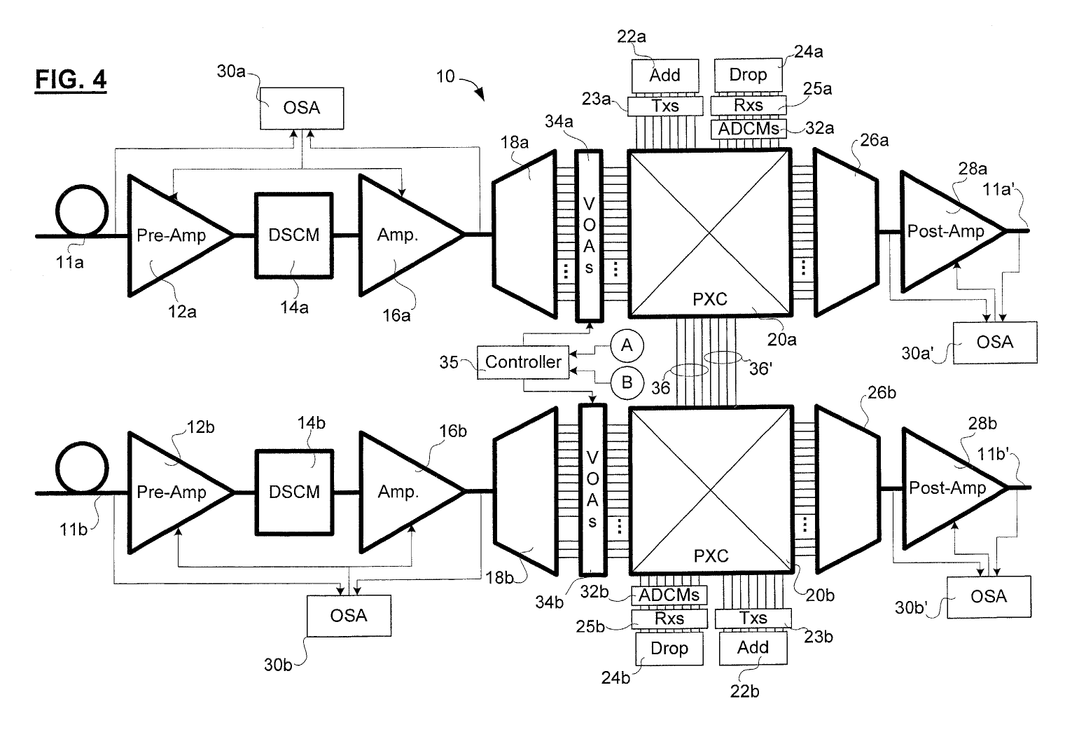

As illustrated in FIG. 4, an all-optical switching site 10 may interconnect two (or more) optical fiber links (11a-11a′,11b-11b′) in a limited manner. A set of transfer add/drop paths 36 are used to switch channels from the input optical fiber link 11a to output optical fiber link 11b′, and another set of transfer add/drop paths 36′ are used to switch from 11b to 11a′. The amount of insertion loss of a PXC generally depending on technology used and the number of switched channels. Smaller PXCs generally have less insertion loss than larger PXCs. Consequently, the use of two smaller PXCs in lieu of a larger PXC reduces insertion loss at the site 10. The number of channels available for switching is equal to the number of transfer add/drop paths 36, 36′.

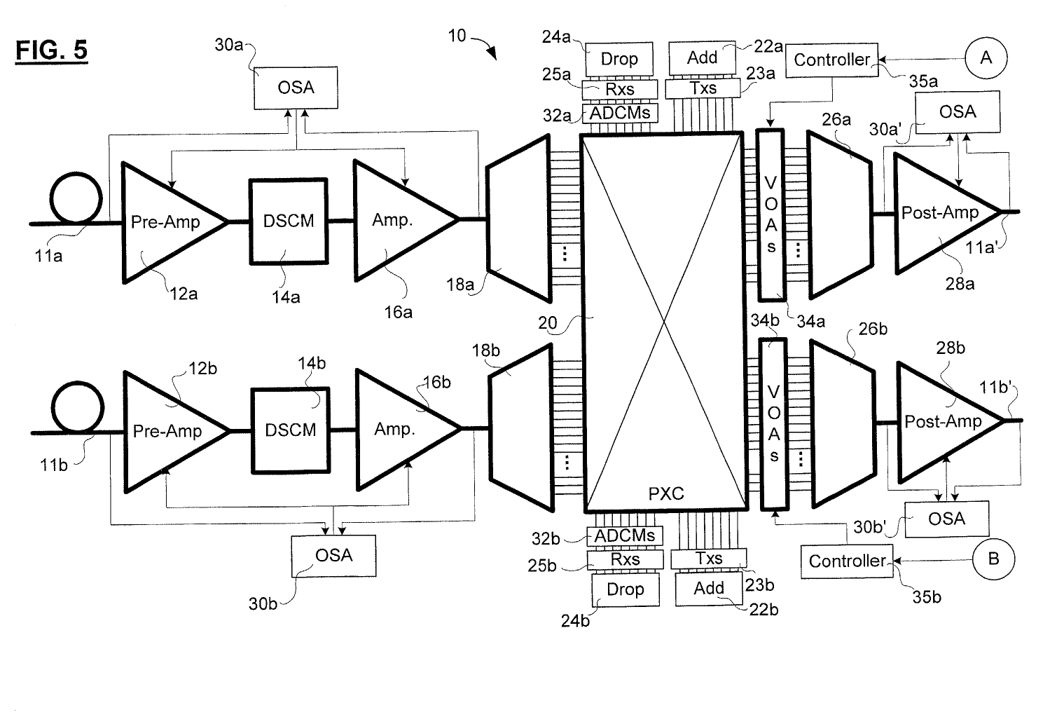

The VOAs 34a,b illustrated in FIG. 4 are located upstream of the PXCs 20a,b. This is a viable configuration provided that control processes for the VOAs 34a,b are adapted to compensate for the position of the VOAs 34a,b. If a channel (ch1) is switched from 11a to 11b′, for example, attenuation of the ch1 has to be performed by a VOA in VOAs 34a. Furthermore, if a channel (ch2) is added to the optical fiber link 11a′, the signal strength of the ch2 must be controlled through the transmitter 23a or 23b in the add path. Consequently, controller 35 preferably controls VOAs 34a, VOAs 34b, and transmitters 23a,b, in response to control feedback received from components of 11a′ and 11b′. Alternatively, at the time that the PXC 20 is provisioned to perform switching through a transfer add/drop path 36, 36′ (to transfer a channel from 11a to 11b′, for example), a controller 35b (FIG. 5) can be programmed to forward the channel signal intensity balance feedback to a controller 35a. In this configuration, the controller 35a also sends control information to the add path transmitters of PXC 23a based on channel signal intensity balance feedback received from controller 35a, if an added channel is to be switched to 10b′.

The pre-amplifiers 12a,b and power amplifiers 16a,b are controlled by OSAs 30a,b, respectively, and a separate OSAs 30a′,b′ are used to control post-amplifiers 28a,b respectively, in the third embodiment. The use of two separate amplifier controllers is particularly useful when the all-optical switching site 10 has a high insertion loss requiring two more amplifiers on output optical fiber links 11a′,b′.

As illustrated in FIG. 5, a plurality of optical fiber links can be cross-connected by a PXC 20. The PXC 20 can switch channels from input optical fiber link 11a to output optical fiber link 11b′, or from 11b to 11a′, as long as the wavelengths of channels launched on an output optical fiber link (11a′ or 11b′) do not overlap. In order to switch a signal that was received on one channel to an output optical fiber link that already carries a wavelength overlapping channel, the switched channel has to be converted to an unused wavelength band. As many optical fiber links can be added as the PXC can support. PXCs with the ability to switch a greater number of channels, however, may incur greater insertion loss, and therefore limit the reach of the channels passing therethrough. Another range limiting factor associated with PXCs is redundancy. Some PXCs are configured to split and recombine channels as a failsafe precaution. Thus, double the switching capacity of the PXC is required to provide full redundancy, in comparison with the switching capacity of a non-redundant PXC. The PXCs of any of the embodiments described previously can be configured as either redundant or non-redundant switching sites.

In general, the greater the insertion loss, the greater the number of on-site amplifiers required to maintain channel signal intensity. Given that there is a limit to how many times a signal carried on a channel can be amplified before regeneration is required; there is a trade-off between cross-connecting many channels and the distance over which each of the many channels may be propagated prior to regeneration.

FIG. 6 is a schematic diagram of an ADCM 32 in accordance with the invention. The ADCM 32 is adapted to apply dispersion compensation to a received signal, depending on an estimated or observed signal dispersion. The ADCM 32 includes a dispersion compensation element (DCE) 38 adapted to apply a controlled amount of dispersion compensation to a received signal. The DCE 38 may be a virtually imaged phase array (VIPA) or a fiber Bragg grating (FBG) device, for example, each of which is known in the art. The ADCM 32 also includes an adaptive controller 40 enabled to control the amount of dispersion compensation applied by the DCE 38. The adaptive controller 40 may be configured to compute a coarse-grained signal dispersion adjustment setting based on an estimate of a dropped channel's net dispersion. The estimate is preferably based on information communicated to the adaptive controller 40 by an agile network controller (not shown). The coarse-grained signal dispersion adjustment is applied before feedback related to the signal is available. The coarse-grained signal dispersion adjustment may be computed using any one or more of several parameters communicated to, or stored by, the adaptive controller 40. The parameters may include, but are not limited to: a distance that the optical signal has traveled through the network; the type of optical fiber links over which the signal has been conveyed; the channel's center wavelength and, an amount of dispersion compensation applied to the channel a last time the channel was dropped to the ADCM 32. Thereafter, the adaptive controller 40 receives control feedback respecting the intra-channel dispersion of the signal the ADCM 32 outputs and, when applicable, directs the DCE 38 to adjust the dispersion compensation applied to the signal.

In accordance with the embodiment illustrated in FIG. 6, the receiver (Rx) 42 generates the control feedback, and sends the control feedback to the adaptive controller 40. An isolator 44 may be added to prevent reflected signal intensity from interfering with upstream network elements.

The control feedback preferably includes a measure of a parameter that is related to signal dispersion. One example of such a measure is signal quality (Q), which is readily measured by an eye-closure diagram generated by the receiver (Rx). Other parameters include a signal-to-noise ratio (SNR) of the received signal; a signal dispersion measure; a spectral content analysis; and, a bit error rate (BER) associated with data encoded by the signal, all of which are well known in the art. Alternatively, a sample of the signal can be tapped from the output of the DCE 38, and sent to a dispersion measurement device. The dispersion measurement device 46 directly or indirectly measures the dispersion of the signal, either by optical measurements, or OE conversion using a second receiver. An advantage of the dispersion measurement device 46 is that incumbent receivers 42 do not have to be re-provisioned to provide the control feedback to the adaptive controller 40. In certain receivers, however, it may be more efficient to re-use the measures of signal quality, etc. generated by the receiver 42 to generate the control feedback.

The invention therefore provides a versatile all-optical switching site 10 for an agile optical network that permits a channel to be selectively dropped using an adaptive dispersion compensation module 32 to compensate for channel dispersion in response to feedback signals indicative of signal quality, or the like. The all-optical switching site 10 likewise permits channels to be added by controlling generated signal intensity by tunable optical transmitters 23 while balancing signal strength using variable optical attenuators (VOAs) 34. The all-optical switching site 10 can be overlaid on an electrical cross-connect, or used in a stand-alone configuration.

The embodiments of the invention described above are intended to be exemplary only. The scope of the invention is therefore intended to be limited solely by the scope of the appended claims.

We claim:

1. An all-optical switching site for an agile optical network connected to at least one input optical fiber link and at least one output optical fiber link, each of which transport a plurality of wave division multiplexed (WDM), or dense wave division multiplexed (DWDM) channels, the all-optical switching site comprising:
an optical add/drop multiplexer having add paths for adding channels to any of the at least one output optical fiber links, and drop channels for extracting channel signals from any of the at least one input optical fiber links;
an adaptive dispersion compensation module (ADCM) in each drop path adapted to compensate for intra-channel wavelength dispersion in a received dropped channel signal; and
an optical transmitter for each add path.

2. An all-optical switching site as claimed in claim 1 wherein the optical transmitter for each add path comprises a tunable optical laser.

3. An all-optical switching site as claimed in claim 1 wherein the ADCM comprises:
a dispersion compensation element (DCE) adapted to apply dispersion compensation to the channel signal; and
an adaptive controller (AC) adapted to control the dispersion compensation applied by the DCE.

4. An all-optical switching site as claimed in claim 3 wherein the AC is adapted to receive control feedback from a downstream signal analyzer, and to use the feedback to adjust the dispersion compensation applied to the dropped channel signal, in order to minimize the intra-channel dispersion of the dropped channel signal.

5. An all-optical switching site as claimed in claim 4 wherein the control feedback is generated at one of:
a signal analyzer that receives a portion of the channel signal via a drop path signal tap; and
a receiver adapted to convert the channel signal to a digital electrical signal.

6. An all-optical switching site as claimed in claim 5 wherein the control feedback comprises a parameter related to dispersion.

7. An all-optical switching site as claimed in claim 6 wherein the parameter comprises at least one of: a signal-to-noise ratio; a signal dispersion measure; at least one feature of an eye-closure diagram; a spectral content analysis of the signal; and a bit error rate associated with data encoded by the signal.

8. An all-optical switching site as claimed in claim 5 wherein, at the time of provisioning a channel to be dropped to a drop path, the adaptive controller computes a coarse-grain signal dispersion adjustment setting based on an estimate of the channel signal's intra-channel dispersion.

9. An all-optical switching site as claimed in claim 8 wherein the estimated dispersion is calculated using at least one of: a distance that the optical signal has traveled through the network; the type of optical fiber links over which the signal was conveyed; the channel's center wavelength; and, the amount of dispersion compensation applied to the channel a last time the channel was dropped.

10. An all-optical switching site as claimed in claim 1 wherein the all-optical switching site comprises a receive path for each of the at least one input optical fiber links, each receive path comprising:
an optical pre-amplifier;
a bulk dispersion slope compensation module (DSCM) adapted to correct for intra-channel dispersion incurred in all of the channels during transmission through the input optical fiber link;
an optical power amplifier; and
a de-multiplexer for de-multiplexing the plurality of channels.

11. An all-optical switching site as claimed in claim 10 wherein the optical add/drop multiplexer further comprises an all-optical switch adapted to selectively switch each de-multiplexed channel and each added channel to one of a drop path, and an output channel path.

12. An all-optical switching site as claimed in claim 11 wherein each output channel is conveyed over a respective output channel path prior to multiplexing, and each output channel further comprises a variable optical attenuator (VOA) adapted to adjust the signal intensity of the channels, to permit the all-optical switching site to dynamically control inter-channel intensity balance for channels output on a common output optical fiber link.

13. An all-optical switching site as claimed in claim 12 further comprising a VOA controller for controlling the VOAs of each output channel path that is multiplexed onto a given output optical fiber link, wherein the VOA controller is further adapted to:
receive inter-channel intensity balance information from a downstream optical signal analyzer;
calculate changes to the amount of attenuation to be applied to respective channel signals to control inter-channel intensity balance; and
control the attenuation of respective channel signals accordingly.

14. An all-optical switching site as claimed in claim 13 wherein:
the all-optical add/drop multiplexer comprises a plurality of optical switches;
at least some of the add/drop paths of each of the optical switches are transfer add-drop paths;
each transfer add-drop path is connected to another all-optical add/drop multiplexer; and
the transfer add-drop paths are adapted to switch channels from the all-optical add/drop multiplexer to the another all-optical add/drop multiplexer.

15. An all-optical switching site as claimed in claim 11 wherein the optical add/drop multiplexer comprises a single optical switch with a plurality of input optical fiber links and a plurality of output optical fiber links, wherein the optical switch is further adapted to switch de-multiplexed channels of any of the plurality of input optical fiber links to respective output channels of any of the output optical fiber links.

16. An all-optical switching site as claimed in claim 13 wherein the optical switch is a fully redundant optical cross-connect with duplication of every channel signal conveyed through the optical switch, and the all-optical switching site further comprises an additional amplifier to compensate for signal intensity lost by splitting and recombining the channel signal.

17. An all-optical switching site as claimed in claim 13 wherein the all-optical switch de-multiplexes and switches only a sub-set of the channels carried on the all-optical switch's input optical fiber link, and the remainder of the channels bypass the all-optical add/drop multiplexer.

18. A method of compensating for net dispersion of a signal transmitted over a variable number of optical fiber links in a wave division multiplexed/dense wave division multiplexed optical network, comprising steps of:
receiving the signal on a channel;
analyzing a quality of the received signal;
sending a measure of the quality to an adaptive controller (AC) of a dispersion compensation element (DCE);
computing a dispersion compensation adjustment at the AC using the measure of quality; and
controlling the DCE to apply the dispersion compensation adjustment to the signal in order to reduce intra-channel dispersion of the signal.

19. A method as claimed in claim 18 wherein the step of receiving the signal comprises using a receiver to perform steps of:
converting the signal from an optical signal to an analog electrical signal; and
computing an eye-closure diagram using properties of the analog electrical signal.

20. A method as claimed in claim 19 wherein the step of analyzing comprises a step of determining a quality of the signal using properties of the eye-closure diagram.

21. A method as claimed in claim 18 wherein the step of receiving comprises steps of receiving a portion of the signal sent to the DCE at a signal analyzer.

22. A method as claimed in claim 21 wherein the step of analyzing comprises a step of analyzing the optical signal at the signal analyzer, in order to measure signal quality.

23. A method as claimed in claim 21 wherein the step of receiving further comprises steps of:
converting the optical signal into an analog electrical signal; and
computing an eye-closure diagram using properties of the analog electrical signal.

24. A method as claimed in claim 23 wherein the step of analyzing comprises a step of determining a quality of the signal using at least one property of the eye-closure diagram.
